(19) United States
(12) Patent Application Publication
(10) Pub. No.: US 2023/0276407 A1
(43) Pub. Date: Aug. 31, 2023

(54) METHODS FOR PAGING A WIRELESS DEVICES, RELATED NETWORK NODES AND WIRELESS DEVICE

(71) Applicant: Sony Group Corporation, Tokyo (JP)

(72) Inventors: Anders BERGGREN, Lund (SE); Basuki PRIYANTO, Lund (SE); Nafiseh MAZLOUM, Lund (SE); Torgny PALENIUS, Barseback (SE)

(21) Appl. No.: 18/017,832

(22) PCT Filed: Jul. 8, 2021
(86) PCT No.: PCT/EP2021/068961

§ 371 Date: Jan. 24, 2023

(30) Foreign Application Priority Data
Aug. 6, 2020 (SE) 2050938-6

(51) Int. Cl. H04W 68/02; H04W 24/08

(52) U.S. Cl. CPC H04W 68/02; H04W 24/08

(57) ABSTRACT

A method is disclosed, performed by a Radio Access Network, RAN, node, for paging one wireless device of one or more wireless devices monitoring paging in a cell controlled by the RAN node. The method comprises broadcasting RAN signaling for use in determining a paging group by the wireless device; receiving, from a core network, CN, node, a paging request to page the wireless device, wherein the paging request is indicative of assistance information for paging of the wireless device; and transmitting, to the wireless device, a paging indication indicative of a paging group determined based on the paging request.

The present disclosure pertains to the field of wireless communications. The present disclosure relates to methods for paging of one wireless device of one or more wireless devices, a related wireless device, a related radio access network node and a related core network node.

### BACKGROUND

In 3^{rd} Generation Partnership Project (3GPP) new radio (NR), when a wireless device is in IDLE mode or RRC INACTIVE mode (where RRC stands for Radio Resource Control), the wireless device needs to listen to a channel for potential paging. In order to reduce power consumption, a wireless device may use a discontinuous reception (DRX) and may only listen to paging at paging occasions (POs). With existing settings and configurations of DRX cycles and POs, many wireless devices listen to the same POs, monitoring the channel for potential paging, such as monitoring the control channel for paging Downlink Control Information (DCI) and a subsequent paging message in the data shared channel. When a wireless device detects and successfully decodes a paging DCI and subsequently paging message, but the paging message was not intended for the wireless device, (such as when a Temporary Mobile Subscriber Identity (TMSI) of the wireless device is not comprised in a Remaining Minimum System Information (RMSI) of a Physical Downlink Shared Channel (PDSCH)), this is referred to as a false paging and leads to an extra overhearing cost at the wireless device. The overhearing cost may be seen as an increased power consumption at the wireless device due to overhearing a paging message intended for another wireless device. This is particularly detrimental when wireless devices with different paging probabilities are listening to the same PO. The energy cost of false paging can become significant if for example wireless devices with a low paging probability are configured to listen to the same POs as wireless devices having a high paging probability.

### SUMMARY

Accordingly, there is a need for devices and methods for paging one wireless device of one or more wireless devices monitoring paging in a cell controlled by the RAN node, which mitigate, alleviate or address the shortcomings existing and provides a paging grouping mechanism which reduces the cost of overhearing due to false paging(s).

Disclosed is a method, performed by a Radio Access Network, RAN, node, for paging one wireless device of one or more wireless devices monitoring paging in a cell controlled by the RAN node. The method comprises broadcasting RAN signaling for use in determining a paging group by the wireless device. The method comprises receiving, from a core network, CN, node, a paging request to page the wireless device, wherein the paging request is indicative of assistance information for paging of the wireless device. The method comprises transmitting, to the wireless device, a paging indication indicative of a paging group determined based on the paging request.

A Radio Access Network, RAN, node is disclosed. The RAN node comprising circuitry, wherein the circuitry is configured to cause the RAN node to perform any of the methods disclosed herein.

It is an advantage of the present disclosure that the number of false paging is reduced, since only wireless devices associated to the paging group indicated in the paging indication will proceed to decode a subsequent paging message carried in PDSCH. It is a further advantage that the paging procedure according to the present disclosure allows group paging of wireless devices without having to add wake-up signaling, which allows for a more efficient use of available resources. A further benefit is that the paging grouping according to the present disclosure is compatible with legacy wireless devices.

Disclosed is a method, performed by a core network node, for paging one wireless device of one or more wireless devices monitoring paging in a cell controlled by a Radio Access Network, RAN, node. The method comprises transmitting, to the RAN node, control signaling assisting the RAN node in determining paging groups based on paging probability. The method comprises transmitting, to the RAN node, a paging request to page the wireless device, wherein the paging request is indicative of assistance information for paging.

Further, a core network node is disclosed. The core network node comprising circuitry, wherein the circuitry is configured to cause the core network node to perform any of the methods disclosed herein.

It is an advantage of the present disclosure that the control signaling allows the RAN node to determine paging groups based on current conditions in the cell, such as to the number of wireless devices in the cell having a certain paging probability. By enabling the RAN node to group the wireless devices in paging groups dynamically, the RAN node can group the wireless devices efficiently. Hence, the number of false paging of the wireless devices can be further reduced. Another benefit is that the paging grouping according to the present disclosure is compatible with legacy wireless devices.

Further, a method is disclosed, performed by a wireless device, for handling paging of the wireless device, wherein the wireless device is monitoring paging in a cell controlled by a Radio Access Network, RAN, node. The method comprises receiving, from the RAN node, RAN signaling enabling the wireless device to determine its paging group. The method comprises determining a paging group based on the RAN signaling. The method comprises monitoring, a paging occasion for a paging indication indicative of the determined paging group.

Further, a wireless device is disclosed. The wireless device comprising circuitry, wherein the circuitry is configured to cause the wireless device to perform any of the methods disclosed herein.

It is an advantage of the present disclosure that the wireless devices can be grouped, such as dynamically grouped, in paging groups. Thereby, the grouping may be adapted to different conditions in the cell, such as to the number of wireless devices in the cell having a certain paging probability at any given time. By being grouped in paging groups and monitoring paging occasions for a paging indication indicative of the paging group of the wireless device, the number of false paging of the wireless device can be reduced, which reduces the energy consumption of the wireless device. A further benefit is that the paging grouping according to the present disclosure is compatible with legacy wireless devices.

### BRIEF DESCRIPTION OF THE DRAWINGS

The above and other features and advantages of the present disclosure will become readily apparent to those skilled in the art by the following detailed description of example embodiments thereof with reference to the attached drawings, in which:

FIG. 1 is a diagram illustrating an example wireless communication system comprising an example radio access network node, an example core network node and example wireless devices according to this disclosure,

FIG. 2 is a signaling diagram illustrating an example message exchange between an example wireless device 300, an example RAN node 400 and an example core network node 600 during an example paging operation according to this disclosure,

FIG. 3 is a diagram illustrating a multiplexing of paging occasions in a frequency domain according to this disclosure,

FIG. 4 is a flow-chart illustrating an example method, performed in a RAN node, for paging one wireless device of one or more wireless devices monitoring paging in a cell controlled by the RAN node according to this disclosure,

FIG. 5 is a flow-chart illustrating an example method, performed in a core network node of, for paging one wireless device of one or more wireless devices monitoring paging in a cell controlled by the RAN node according to this disclosure,

FIG. 6 is a flow-chart illustrating an example method, performed in a wireless device, for handling paging of the wireless device according to this disclosure,

FIG. 7 is a block diagram illustrating an example RAN node according to this disclosure,

FIG. 8 is a block diagram illustrating an example core network node according to this disclosure, and

FIG. 9 is a block diagram illustrating an example wireless device according to this disclosure.

### DETAILED DESCRIPTION

Various example embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

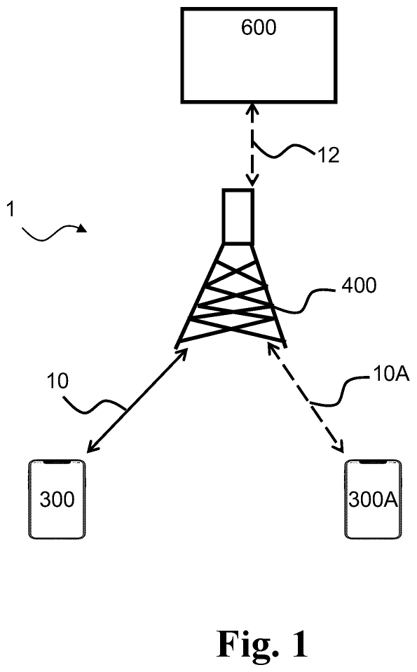

FIG. 1 is a diagram illustrating an exemplary wireless communication system 1 comprising an exemplary network node 400 and an exemplary wireless device 300 according to this disclosure. The exemplary wireless communication system further comprises an exemplary core network, CN, node 600, such as e.g. a Mobility Management Entity (MME) or a 5G Core Access and Mobility Management Function (AMF).

As discussed in detail herein, the present disclosure relates to a wireless communication system 1 comprising a cellular system, e.g. a 3GPP wireless communication system. The wireless communication system 1 comprises one or more wireless device(s) 300, 300A and/or one or more radio access network node(s) 400, such as one or more of: a base station, an eNB, a gNB and/or an access point.

The radio access network, RAN, node disclosed herein may be seen as a functional unit which may include a radio access network node 400 operating in the radio access network, such as a base station, an evolved Node B (eNB), and/or a NodeB (gNB).

The wireless communication system 1 may comprise a core network node 600. The core network node 600 is part of a core network.

The CN node disclosed herein may be seen as a functional unit which may include a CN node 600 operating in a core network, such as e.g. a Mobility Management Entity (MME) or a 5G Core Access and Mobility Management Function (AMF).

A wireless device may refer to a mobile device and/or a user equipment (UE). Optionally, the wireless device may comprise an Internet-of-things (IoT) device.

The wireless device 300, 300A may be configured to communicate with the RAN node 400 via a wireless link (or radio access link) 10, 10A.

A core network, CN, node disclosed herein refers to a network node operating in the core network, such as in the Evolved Packet Core Network, EPC, and/or a 5G Core Network, 5GC. Examples of CN nodes in EPC include a Mobility Management Entity, MME and/or an Access and Mobility Management Function, AMF.

The wireless device 300, 300A may be configured to communicate with the CN node 600 via a RAN node 400, which is configured to communicate with the CN node 600 via link 12.

When the wireless device, such as the UE, is in IDLE mode or RRC INACTIVE mode, the wireless device needs to listen to a channel (i.e. paging channel) for potential paging. The channel may be a downlink channel from a RAN node. To reduce power consumption the wireless device may use discontinuous reception (DRX). When configured with DRX, the wireless device monitors one PO per DRX cycle where each PO is a set of Physical Downlink Control Channel (PDCCH) monitoring occasions. Each PO may comprise one or more time slots, such as one or more subframes or one or more Orthogonal Frequency-Division Multiplexing (OFDM) symbols, where a paging Downlink Control Information (DCI), such as a DCI where the Cyclic Redundancy Check (CRC) of the DCI is scrambled by a P_RNTI, may be received by the wireless device. A Paging Frame (PF) is one Radio Frame and may comprise one or more PO(s) or starting point of a PO. Typically, one P_RNTI is used by all wireless devices in a cell. Therefore, all wireless devices that have been scheduled to monitor paging proceed to decode the subsequent paging message even if only one wireless device in the PO is paged.

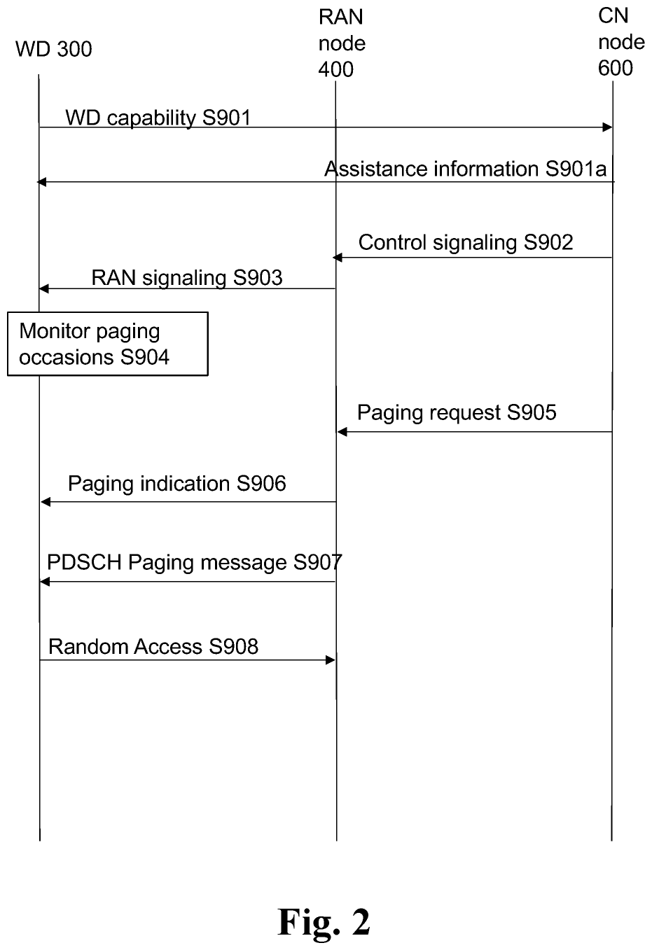

FIG. 2 shows a signaling diagram illustrating an example message exchange between an example wireless device 300, an example RAN node 400 and an example core network node 600 during an example paging operation according to the current disclosure.

The wireless device 300 performs an attach procedure with the core network node 600, such as the MME or AMF, and exchanges S901 wireless device information (such as wireless device capability information), for negotiating information related to a paging probability of the wireless device 300. The wireless device 300 may indicate by capability information whether the wireless device is capable of supporting paging group operation. For example, the wireless device 300 may provide additional UE paging probability information in the Attach Request message. Then the CN node may determine assistance information based on the UE paging probability information and/or other information such as statistics etc. The assistance information 901a with the paging probability (such as NASprob) may be sent from the CN node 600 to the wireless device 300 in one or more Attach Accept messages and/or a Tracking Area Update message. In other words, when the wireless device 300 supports group paging operation, the wireless device 300 may obtain the paging probability (NAS_{prob}) that may be negotiated between the wireless device and MME via NAS signalling. The exchange of information may comprise the wireless device transmitting wireless device information to the core network node 600 and receiving a paging probability. The wireless device information may comprise information enabling the CN node to provide the wireless device with the paging probability of the wireless device. The exchange of information may further comprise the core network node 600 transmitting assistance information, such as assistance information for paging, such as paging probability, to the wireless device 300.

The core network node 600, such as the MME or the AMF, transmits S902 control signaling for assisting the RAN node 400 in determining paging groups to the RAN node 400. The control signaling may comprise paging grouping assistance information. For example, the control signalling may enable the RAN node to determine paging probability threshold(s) which may be sent in RRC. For example, paging grouping configuration information is broadcasted by the RAN node via system information in relevant cells (see step S903), such as in cells where data is to be received, e.g. based on higher layer information. The paging grouping assistance information may comprise paging probabilities, such as a distribution of paging probabilities in a cell of the RAN node. This information may be used by the RAN node to adjust the paging grouping information. Paging grouping information comprises one or more paging probability thresholds, and/or paging group IDs for each paging probability and/or paging probability threshold.

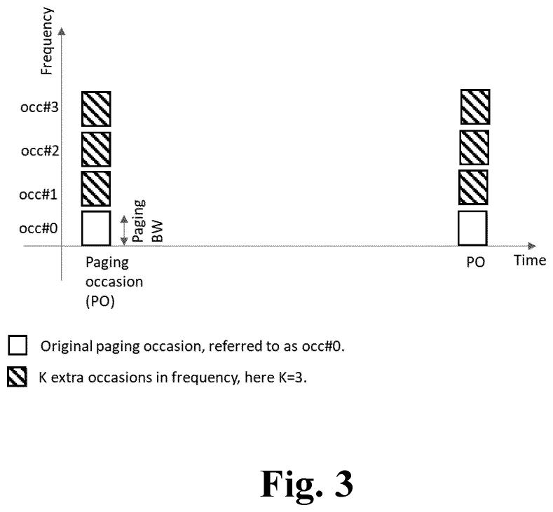

The RAN node 400 may broadcast S903 RAN signaling enabling the wireless device 400 to determine a paging group that the wireless device belongs to. The RAN signaling may comprise paging group information, such as paging grouping configuration information, which allows the wireless device to identify or understand, based on its own paging probability, which group it belongs to. The paging group information may comprise a paging probability or a traffic characteristics, and/or a mapping of the paging groups to the paging probability and/or the traffic characteristics. The paging group information may be indicative of extra resources, such as K extra resources (K<N, where N is the total number of paging groups) multiplexed in frequency on the same timing occasion illustrated in FIG. 3.

The wireless device 300 may be in Idle mode or in RRC Inactive mode, and may monitor S904 paging occasions according to its DRX cycle, and according to the broadcasted RAN signaling (such as paging group information). The wireless device 300 may monitor data sent on a paging occasion and may interpret the data based on the paging group information, such as based on its paging group. The wireless device may filter the paging indications transmitted in the monitored paging occasion based on the paging group information, as explained in more detail below.

The core network node, such as the core network node 600, may transmit S905 a paging message, such as a paging request to page the wireless device, to the RAN node 400. The paging message may be indicative of assistance information for paging of the wireless device, such as paging probabilities and/or traffic characteristics of the wireless device to be paged. The RAN node may further use the paging probability and/or traffic characteristics to determine the paging group of the associated wireless device. The paging message is typically transmitted to the RAN nodes of the cells in which the wireless device should be paged.

The RAN node, such as the RAN node 400, may transmit S906 a paging indication to the wireless device 300. A paging indication may be seen as an indicator used by the RAN node to indicate to the wireless device that a wireless device in the paging group is about to be paged. For example, the paging indication may comprise a paging indicator, such a paging DCI. The paging indication may be indicative of a paging group determined based on the paging request. The paging indication may, in one or more example methods, comprise and/or be scrambled with a new paging group identifier, ID (which may be similar to P-RNTI) to trigger wireless devices belonging to the intended paging group to prepare and to proceed to receiving a Paging message on PDSCH. The paging indication may, in one or more example methods, comprise extra DCI bits for indicating the paging group.

The RAN node, such as the RAN node 400, may transmit S907 the Paging message on PDSCH.

When the wireless device intended for the paging, such as the wireless device 300, is in the cell, the wireless device may respond to the paging message by initiating S908 a Random Access procedure towards the RAN node 400. Initiating the Random Access procedure may comprise transmitting an RRC Connection Request to the RAN node 400.

The paging DCI comprises details of frequency and time resources for the paging. The PDSCH comprises a RMSI/TMSI of the target wireless device which have been paged. Only after decoding the PDSCH will the wireless device know whether it is paged or not. The event where a wireless device detects and/or successfully decodes a paging DCI, but its RMSI/TMSI is not included in the PDSCH is referred to as a “false paging”. A false paging leads to an overhearing cost, such as an increased power consumption, at the wireless device. A false paging may occur for example when a UE overhears a paging directed to other UEs. For example, false paging may happen when the UE does decode everything correctly, but the signaling from the radio access network node to the other devices paging is overheard by the UE.

As is detailed in the Appendix, with the existing settings and configurations of DRX cycles and POs, many wireless devices may listen to the same POs for monitoring the channel for potential paging DCI. The cost of false paging can become significant if wireless devices with a low paging probability are configured to listen to the same POs as the wireless devices having a high paging probability. The paging probability may be seen as a metric on the probability of a wireless device receiving a paging message over a time period and may be based on, for example, statistical information of the wireless device.

Even wireless devices having the same paging probability may experience false paging, since not all of the wireless devices are being paged at the same time. The cost, however, is even higher if a first wireless device is to listen to the same paging occasion as a second wireless device having a higher paging probability than the first wireless device.

The current disclosure addresses, inter alia, the false paging issue and provides a paging grouping mechanism which reduces the cost of overhearing due to false paging.

The example methods according to the current disclosure introduce group paging in order to prevent all wireless devices listening to one PO from overhearing. Instead, the wireless devices are grouped based on the paging probability. Each wireless device may monitor a paging indicator (PI) based on a paging group which is calculated based on the paging probability of the wireless device. The paging probability may be reported by the wireless device or decided in the CN node based on e.g. statistic.

The grouping of the wireless devices may be implemented by introducing filtering and/or categorizing within the PO.

According to one or more example methods disclosed herein, the DCI may comprise additional information, such as extra DCI bits, that indicates a paging group. The wireless device may only monitor succeeding PDSCH when the additional information, such as the extra DCI bits, matches the paging group of the wireless device.

According to one or more example methods disclosed herein, a paging group identifier (ID) may be assigned. The paging group ID may be used to calculate an enhanced P-RNTI. The CRC of the DCI may be scrambled with the new P-RNTI. The paging group IDs may be determined based on a paging probability so that wireless devices having similar paging capabilities, such as paging probabilities, are grouped together and listen to the same paging indication.

In one or more example methods, additional resources may be added in a frequency domain, such as at each paging occasion in the time domain, to page several wireless devices simultaneously.

The example methods disclosed herein provide a wireless device paging grouping mechanism, compatible with an existing paging procedure, such as a legacy paging procedure, without using a wake-up signal (WUS), to reduce the number of false paging for non-target wireless devices. Non-target wireless devices may herein be seen as wireless devices for which the paging is not intended.

The paging grouping mechanism for the wireless devices according to one or more example methods disclosed herein may be seen as an enhancement of paging procedure, for example, by adding grouping to the existing paging procedure which allows the RAN node, such as an eNB or gNB, to group the wireless devices. The signaling of the grouping of the wireless devices may be done via a modified paging indication, such as a modified paging DCI, which may also be referred to as an enhanced paging DCI. Example methods for modifying the DCI according to this disclosure are provided. In one or more example methods, N extra bits may be added to the paging DCI where N can be associated to the number of the UE paging group and each bit represents one group. In the legacy NR, the paging DCI uses DCI format 1_0, which comprises 6 reserved bits. Hence, to enhance paging DCI functionality for group paging all or some parts of these extra bits may be used. The same RNTI as the existing paging RNTI, e.g., P_RNTI may be used as paging indication for enhanced paging DCI.

In one or more example methods, equivalent to N number of UEs paging groups, N new paging group IDs in addition to P_RNTI (or a mixture of P_RNTI and N new paging group IDs) are introduced. For legacy NR, CRC is scrambled/masked with P_RNTI (CRC×P_RNTI). For example, CRC may be scrambled/masked with P_RNTI and a group ID (CRC×P_RNTI×group ID). To page a wireless device group, the CRC of the paging DCI may be scrambled by a new group ID corresponding to the paging group ID of the target wireless device group. The existing paging RNTI, e.g., P_RNTI may be used to page wireless devices when more than one paging group needs to be paged.

In one or more example methods, X extra bits may be added to enhanced paging DCI. The extra X bits is equal to ceil(log 2(N)) where N is the total number of paging groups, M=N−1 is the number wireless device paging groups and one value (such as all bits set to one (or zero)) may be reserved for the case where more than one UE needs to be paged (such as all wireless devices). For example, the same RNTI as the existing paging RNTI, e.g., P_RNTI is used as paging indication for the enhanced paging DCI.

An advantage of the example methods is that the wireless device does not need to search for at least two paging IDs, i.e., its group paging ID and all paging ID. The paging IDs may also be used to identify paging group combinations, for instance a paging ID may be assigned to page two or more paging groups simultaneously.

The paging grouping mechanism for the wireless devices according to the example methods disclosed herein may comprise: a paging grouping resource allocation—A wireless device needs to monitor the resource where paging DCI with grouping may be allocated by the RAN node. Different approaches may be used depending on how the signaling of wireless device paging groups is performed. In one or more example methods, there is no need for extra/separate time or frequency resources since grouping of the wireless devices for a PO is taken care of using N extra bit within the DCI. Thereby, legacy POs may be used and may be determined according to the Appendix. The wireless devices may monitor the channel at the POs for the enhanced paging DCI.

In one or more example methods, a plurality of configurations can be used: A) There is no change to the PO used and no extra resources are allocated for paging of the paging groups. The wireless devices may monitor, such as look, for their own group-ID and all-group ID. By grouping the wireless devices based on their paging probability or their traffic characteristics, the wireless devices with a lower paging probability than other wireless devices will not wake up falsely as often; B) K extra resources (K<N, where N is the total number of paging groups) multiplexed in frequency on the same timing occasion as PO may be used to enable wireless device paging groups (as illustrated in FIG. 3). A plurality of paging groups may thus be paged simultaneously in the same PO in time. An example mapping strategy on how the wireless device groups are related to these extra resources is shown in FIG. 3. For instance, assume the total number of grouping N is 7 and 3 extra bits are used to address the group IDs for the N groups. With K=3 extra resources, a group ID for addressing all wireless devices and paging group #1 may be scheduled to listen to the original paging occasion (the original paging occasion may be referred to as a legacy paging occasion or paging occasion #0), paging group #2 and paging group #3 may be scheduled to listen to paging occasion #1 with a frequency location shifted by one paging bandwidth compared to the original paging occasion, paging groups #4 and #5 may be scheduled to listen to paging occasion #2, and paging groups #6 and #7 may be scheduled to listen to paging occasion #3 with their frequency locations shifted by two paging bandwidth and three paging bandwidth compared to the original paging occasion, respectively. This may also be done by multiplexing the paging grouping in the time domain or by a combination of multiplexing in time and frequency domains.

The paging grouping mechanism for the wireless devices according to the example methods disclosed herein may comprise: a higher layer setting and configuration—The information related to wireless device paging groups may be communicated with the wireless devices via system information. The RAN node, such as the gNB, is not aware of traffic characteristics or paging probability of the wireless devices. The core network node, such as the MME or the AMF, may provide this information to the RAN node. The RAN node may use this information to efficiently assign the right set of wireless devices to the same paging group.

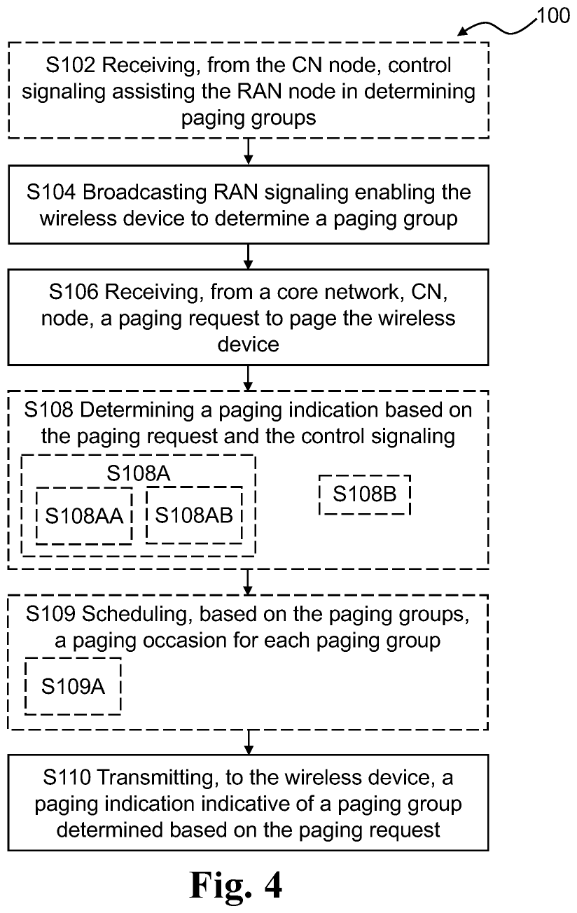

FIG. 4 shows a flow diagram of an example method 100, performed by a Radio Access Network, RAN, node, for paging one wireless device of one or more wireless devices monitoring paging in a cell controlled by the RAN node according to the disclosure. The wireless device may be in IDLE mode or Radio Resource Control (RRC) Inactive mode in the cell controlled by the RAN node.

The method 100 comprises broadcasting S104 RAN signaling for use in determining a paging group by the wireless device, e.g. enabling the wireless device to determine a paging group, such as a paging group to which the wireless device belongs. A paging group may be seen as a group comprising one or more wireless devices, which are grouped based on their paging probability and/or traffic characteristics, so that the wireless device(s) of the group can be paged according to their paging group. In one or more example methods, the RAN signaling enables the wireless device to determine a paging group based on a paging probability and/or a paging probability threshold and/or traffic characteristics of the wireless device. The RAN signaling may for example comprise a mapping between paging groups and any of a paging probability, a paging probability threshold and traffic characteristics. The wireless device may determine, based on the RAN signaling and optionally wireless device information, its paging group, such as the paging group that the wireless device belongs to. The RAN signaling may comprise information indicative of resources in time and/or frequency for paging occasions associated with the respective paging groups. The RAN signaling may comprise information indicative of the increased number of paging occasions Nₛ for a paging frame to be used by the wireless device when calculating the paging occasions. Broadcasting S104 may correspond to S903 in FIG. 2.

The method 100 comprises receiving S106, from a CN node, a paging request to page the wireless device. The paging request indicates to the RAN node that there is data or other information that is to be sent to the wireless device. The paging request is for example indicative of assistance information for paging of the wireless device. In one or more example methods, the assistance information for paging comprises one or more of: a paging probability associated with the wireless device, and a traffic characteristic for the wireless device. The RAN node may further use the paging probability and/or traffic characteristics to determine the paging group of the associated wireless device. The CN node may be a mobility management node located in the core network, such as a Multimedia Management Entity (MME) or a 5G Core Access and Mobility Management Function (AMF). Receiving S106 may correspond to S905 in FIG. 2.

The method 100 comprises transmitting S110, to the wireless device, a paging indication indicative of a paging group determined based on the paging request. For example, the RAN node uses the paging request indicative of the assistance information (such as the paging probability and/or traffic characteristics) to determine the paging group corresponding to the wireless device, and generates the paging indication based on the paging group, so that the paging indication indicates the determined paging group. The paging indication instructs the wireless device to decode an upcoming paging message. Transmitting S110 may correspond to S906 in FIG. 2.

In one or more example methods, the paging group is indicated by formatting S108A the paging indication based on the paging group of the wireless device. In other words, the formatting S108A may generate a paging indication for each paging group. It may be envisaged that the formatting S108A provides different paging indications for different paging groups. For example, a paging indication for a first paging group is different from a paging indication from a second paging group. For example, the RAN node uses the first paging group to generate and format the paging indication for paging wireless device(s) belonging to the first paging group.

In one or more example methods, formatting S108A the paging indication comprises encoding S108AA the paging indication with a paging group identifier. Encoding the paging indication may comprise scrambling and/or masking the paging indication. Scrambling may be seen as transposing or inverting a signal or otherwise encoding a message to make the message unintelligible at a receiver not equipped with an appropriately set descrambling means. Scrambling may be accomplished by the addition of components, such as the paging group identifier, to the original signal, such as the paging indication, or the changing of some component of the original signal in order to make extraction of the original signal difficult. Masking may be seen as a process of hiding original data with modified content, such as characters or other data. For example, in this context, the content is modified by adding paging group identifier. For example, N new paging group identifiers may be provided in addition to the P_RNTI (or a mixture of P_RNTI and N new paging group identifiers), where N is the number of wireless device paging groups. In legacy NR, the paging identifier comprises CRC scrambled and/or masked with P_RNTI (CRC×P_RNTI). According to one or more example methods provided herein, the paging group identifiers may be provided by scrambling and/or masking the CRC with the P_RNTI and the group identifier (CRC×P_RNTI×group ID). To page a wireless device group CRC, the paging DCI may be scrambled by a new group identifier, such as the group ID, corresponding to the identifier of the target wireless device group. The legacy paging RNTI, such as the legacy P_RNTI, may be still be used to page wireless devices when more than one group needs to be paged. An advantage related to providing the paging group identifier in the paging indication as disclosed herein is that no extra bits are required in the paging indication (such as paging DCI) to signal the paging groups.

In one or more example methods, formatting S108A the paging indication comprises providing S108AB a paging group identifier in the paging indication. In other words, the paging indication can include the paging group identifier, e.g. in additional bits. In one or more example methods, the paging group identifier is indicated by one or more bits of the paging indication. The one or more bits may be associated with the paging group. The paging group identifier may be indicated by a dedicated bit, such as a dedicated bit for each paging group, or by a combination of bits, such as a dedicated combination of bits for each paging group.

The paging indication may be seen as an explicit indication (illustrated in step S108AB of FIG. 3) or an implicit indication (illustrated in step S108AA of FIG. 3) of for example which PO that is used for the paging group.

In one or more example methods, the paging group identifier is indicated by a dedicated bit of the paging indication. The dedicated bit may be seen as an explicit indication. The dedicated bit may be associated with a specific paging group. For example, N extra bits may be added to the paging DCI, where N is the number of wireless device paging group and each bit may represent one group. In other words, each bit may be associated with one paging group. The DCI having N extra bits may herein be referred to as an enhanced paging DCI. In legacy NR, the paging DCI typically uses DCI format 1_0, which comprises six reserved bits. The enhanced paging DCI may use one or more of these reserved bits, to enhance paging DCI functionality for group paging. The enhanced paging DCI may use the same RNTI as the existing paging RNTI, such as the P_RNTI, as paging indication. By using N extra bits within the paging DCI for indicating the paging group identifier of the wireless devices, there is no need for additional and/or separate time or frequency resources. The POs may thus be determined using the legacy PO formula as shown in the Appendix. Since grouping of the wireless devices for a PO may be handled using N extra bit within the DCI using legacy PO, these example methods have the benefit that they are compatible with legacy wireless devices.

In one or more example methods, the paging group identifier is indicated by a combination of bits of the paging indication. In one or more example methods, the combination of bits is associated with the paging group. For these example methods, X extra bits may be added to the paging DCI, where X denotes the number of extra bits added. The extra X bits may be equal to ceil(log 2(N)) where N is the total number of paging groups, M=N−1 is the number of wireless device paging groups. One value, such as all bits set to one (or zero), may be reserved for the case where more than one UE needs to be paged (for example when all UEs need to be paged). Similar to the example methods where N bits are added to the paging DCI, the same RNTI as the existing paging RNTI, such as the P_RNTI may be used as paging indication for the enhanced paging DCI.

In one or more example methods, the method comprises receiving S102, from the CN node, control signaling assisting the RAN node in determining paging groups based on paging probability and/or traffic characteristics. The control signaling may comprise one or more of: a range of paging probabilities associated with each paging group, paging probability thresholds associated with each paging group, traffic characteristics associated with each paging group and a paging group identifier for each paging group. The control signaling may comprise one or more of: a range of paging probabilities, paging probability thresholds, and traffic characteristics. The control signalling of S102 may be seen as assistance information provided by the CN node. The paging probability, the paging probability threshold and the traffic characteristics may be associated with the wireless devices monitoring paging in a cell controlled by the RAN node. The control signaling may comprise a paging probability distribution and/or traffic characteristics distribution of the wireless devices associated with a cell of the RAN node. Associated with the cell may herein be seen as the wireless devices having performed an attach procedure to the cell and being in IDLE mode or RRC Inactive mode and monitoring paging in the cell controlled by the RAN node. The paging probability distribution and/or traffic characteristics distribution in the cell may vary over time.

In one or more example methods, the method comprises determining S108 the paging indication indicative of the paging group based on the paging request and optionally based on the control signaling. The control signaling may e.g. be used to determine, such as dynamically determine the paging groups for the wireless devices. The RAN node may determine the paging grouping, such as the paging groups, for the wireless device(s) dynamically based on the control signaling received from the core network node. This has the benefit that the paging grouping may be dynamically adjusted at the RAN node, so that the paging groups and the associated paging indication may be scheduled more effectively. While legacy grouping of wireless devices, such as grouping related to Wake Up Signaling (WUS), is typically based on fixed paging probability thresholds, such as for example grouping wireless devices with a paging probability in the range of 0-9% in a first group, wireless devices with a paging probability in the range of 10-19% in a second group, . . . , and wireless devices with a paging probability in the range of 90-100% in a tenth group, the RAN node according to the example embodiments herein may dynamically determine the paging groups based on the control signaling received from the core network node. If for example the control signaling indicates that only a few wireless devices have a paging probability of 0-20%, these wireless devices may be grouped in a first paging group. If there are many wireless devices having a paging probability of 31-35%, these wireless devices may be grouped in a second paging group. In other words, for example, the control signaling enables the MME to influence paging grouping configuration set by the RAN node. Once the paging groups have been determined based on the control signaling, the RAN node may update the paging grouping configuration. Subsequently, the RAN node may determine the paging indication indicative of the paging groups based on the paging request and the determined paging groups.

In one or more example methods, determining S108 the paging indication comprises determining S108B a paging occasion based on an increased maximum number of paging occasions per paging frame. In one or more example methods, the paging group is indicated by transmitting the paging indication using a paging resource assigned to at least one paging group. For example, one paging resource to support paging groups can be supported by multiplexing in time and frequency. The one or more example methods may comprise increasing a number of POs for a PF, for example by increasing a maximum value of N_{S} to support for example 8 paging occasions when calculating the PO (see Appendix). Thereby, the number of POs in each PF may be increased. By increasing the number of POs in each PF, the paging groups may be spread out over a higher number of POs, such that a fewer number of wireless devices share the same paging monitoring occasion. By combining the increased number of POs with the group paging disclosed herein, the wireless devices may be grouped in a more efficient way. Thereby, the number of false paging may be reduced even further. Another advantage relates to paging of more than one paging group. By using this combined approach fewer number of wireless device groups share the same paging monitoring occasion and less wireless devices may be overhearing paging in one or more paging occasions not intended for these wireless devices.

In one or more example methods, the paging request comprises a request to page a plurality of wireless devices. When the request comprises the request to page a plurality of wireless devices, the assistance information for paging may comprise paging probability or traffic characteristics of each of the plurality of wireless devices. In other words, the paging request may comprise assistance information related to each of the wireless devices that are to be paged.

In one or more example methods, the method comprises scheduling S109, based on the paging groups, a paging occasion for each paging group. Upon determining paging groups for the wireless devices, based on for example the control signaling received from the core network node, the RAN node may schedule paging occasions for the determined paging groups. In other words, the RAN node may assign paging occasions to the paging groups.

In one or more example methods, scheduling S109, based on the paging groups, the paging occasion for each paging group, comprises multiplexing S109A the paging occasions in time and/or in frequency. K extra resources (K<N, where N is the number of paging groups) may be multiplexed in frequency on the same timing occasion as PO are used to enable simultaneous wireless device paging grouping for the same PO in time. An example mapping strategy on how the wireless device groups are related to these extra resources is also provided herein. For instance, assume the total number of grouping N is 7 and 3 extra bits are used to address the group IDs for the N groups. As illustrated in FIG. 3, with K=3 extra resources, a group ID for addressing all wireless devices and paging group #1 may be scheduled to listen to the original paging occasion (the original paging occasion may be referred to as a legacy paging occasion or paging occasion #0), paging group #2 and paging group #3 may be scheduled to listen to paging occasion #1 with a frequency location shifted by one paging bandwidth compared to the original paging occasion, paging groups #4 and #5 may be scheduled to listen to paging occasion #2, and paging groups #6 and #7 may be scheduled to listen to paging occasion #3 with their frequency locations shifted by two paging bandwidth and three paging bandwidth compared to the original paging occasion, respectively. This may also be done by multiplexing the paging grouping in the time domain or by a combination of multiplexing in time and frequency domains.

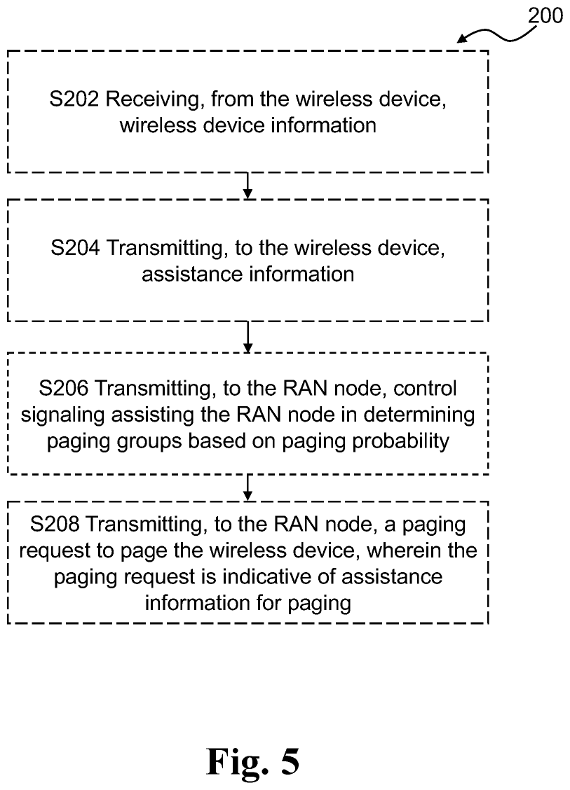

FIG. 5 shows a flow diagram of an example method 200, performed by a core network node, for paging one wireless device of one or more wireless devices monitoring paging in a cell controlled by a RAN node according to the disclosure. The core network node may be an MME and/or an AMF. The method 200 comprises transmitting S206, to the RAN node, control signaling assisting the RAN node in determining paging groups based on paging probability. In one or more example methods, the control signaling comprises one or more of: a range of paging probabilities associated with each paging group, paging probability thresholds associated with each paging group, traffic characteristics associated with each paging group and a paging group identifier for each paging group. Transmitting S206 control signaling may correspond to S902 in FIG. 2.

The method 200 comprises transmitting S208, to the RAN node, a paging request to page the wireless device. The paging request may be indicative of assistance information for paging. In one or more example methods, the paging request comprises one or more of: a paging probability associated with the wireless device, and a traffic characteristic for the wireless device. Transmitting S208 a paging request may correspond to S905 in FIG. 2.

In one or more example methods, the paging request comprises a request to page a plurality of wireless devices. When the request comprises the request to page a plurality of wireless devices, the assistance information for paging may comprise paging probability or traffic characteristics of each of the plurality of wireless devices. In other words, the paging request may comprise assistance information related to each of the wireless devices that are to be paged.

In one or more example methods, the method comprises receiving S202, from the wireless device, wireless device information. The wireless device information may comprise the capability information whether the wireless device support paging grouping. If it supports, the wireless device information may comprise further information related to the paging probability of the wireless device. The wireless device information may be received from the wireless device using Non-Access Stratum, NAS signaling. The NAS signaling may be carried via the RAN node. The wireless device information may further comprise information on Radio Access Technologies (RATs) that the wireless device supports (such as a power class or frequency bands supported by the wireless device). Receiving S202 may be similar to S901 in FIG. 2.

In one or more example methods, the method comprises transmitting S204, to the wireless device, assistance information, such as assistance information for paging. The core network node may determine the assistance information based on the received paging probability and/or previous statistical information, such as traffic characteristics, for the wireless device. This may assist the wireless device to update its paging probability and furthermore, the associated paging group of that paging probability. In one or more example methods, the assistance information for paging comprises one or more of a paging probability and traffic characteristics. In some example methods, the assistance information may comprise paging probability thresholds for the different paging groups and the paging thresholds do not have to be broadcasted by RAN node. The assistance information may be transmitted to the wireless device using NAS signaling. The NAS signaling may be carried via the RAN node. It may be appreciated that the wireless devices knows the paging probability assigned by the CN node to the wireless device to identify which group the WD belongs to. Transmitting S204 may be similar to S901a in FIG. 2.

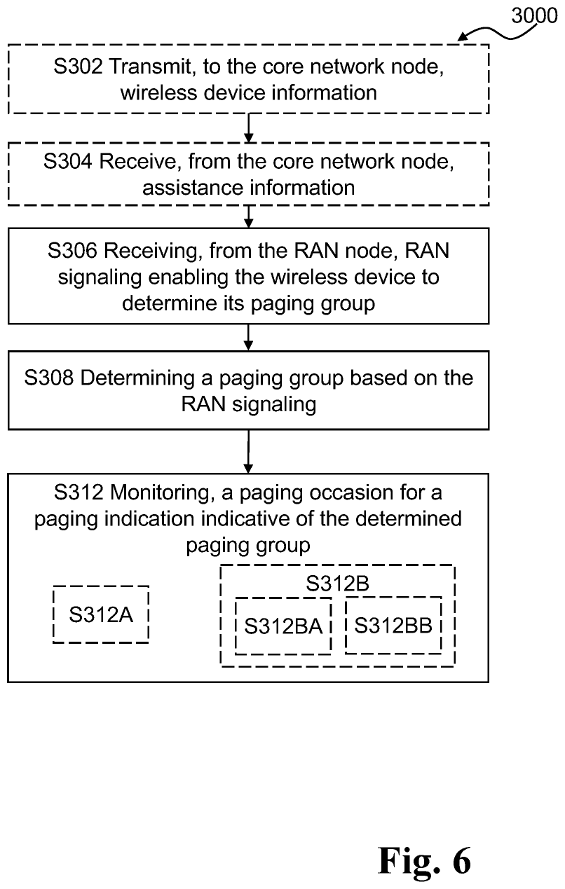

FIG. 6 shows a flow diagram of an example method 3000, performed by a wireless device (e.g. the wireless device disclosed herein, wireless device 300), for handling paging of the wireless device. The wireless device is monitoring paging in a cell controlled by a RAN node according to the disclosure.

In one or more example methods, the method comprises transmitting S302, to the core network node, wireless device information. The wireless device information may comprise information related to paging probability of the wireless device. The wireless device information may be transmitted to the core network node using NAS signaling. The NAS signaling may be carried via the RAN node. The wireless device information may further comprise traffic characteristics of the wireless device. Transmitting S302 wireless device information corresponds to S901 in FIG. 2.

In one or more example methods, the method comprises receiving S304, from the core network node, assistance information, such as assistance information for paging, e.g. obtained based on negotiations with the CN node. The core network node may determine the assistance information based on the received wireless device information, such as paging probability and/or previous statistical information, such as traffic characteristics, for the wireless device. In one or more example methods, the assistance information for paging comprises one or more of a paging probability and traffic characteristics. The assistance information may in some example methods disclosed herein comprise paging probability thresholds for the different paging groups. The assistance information may be received from the core network node using NAS signaling. The NAS signaling may be carried via the RAN node. Receiving assistance information S304 corresponds to S901a in FIG. 2.

The method 3000 comprises receiving S306, from the RAN node, RAN signaling enabling the wireless device to determine its paging group. The RAN signalling of S306 is typically part broadcasted information of S104 of FIG. 4. This is also illustrated in S903 of FIG. 2. The RAN signaling may be indicative of a rule for interpreting the paging indication. In one or more example methods, the RAN signaling is indicative of resources in time and/or frequency for the paging occasion. In one or more example methods, the RAN signaling enables the wireless device to determine its paging group based on the paging probability or the traffic characteristics of the wireless device. The RAN signaling may for example comprise a mapping between paging groups and any of a paging probability, a paging probability threshold and traffic characteristics. The RAN signaling may comprise information indicative of resources in time and/or frequency for paging occasions associated with the respective paging groups. The RAN signaling may comprise information indicative of the increased number of paging occasions Nₛ for a paging frame to be used by the wireless device when calculating or determining the paging occasion(s).

The method 3000 comprises determining S308 a paging group based on the RAN signaling. The wireless device may determine the paging group, such as the paging group that the wireless device belongs to, by comparing the RAN signaling with its wireless device information, such as its traffic characteristics and/or its paging probability.

The method 3000 comprises monitoring S312, a paging occasion for a paging indication indicative of the determined paging group. The wireless device may use the paging group, such as the paging group identifier, to decide if a received paging indication is relevant to the wireless device and/or may use the paging group, such as the paging group identifier, to find the paging occasion associated with (or corresponding to) the paging group, such for example when additional paging occasions are added. A paging occasion associated with (or corresponding to) the paging group may be seen as a paging occasion being determined and/or scheduled based on the paging group. Monitoring S312 may correspond to S904 in FIG. 2.

In one or more example methods, monitoring S312 comprises receiving S312A, from the RAN node, the paging indication indicative of the paging group. Receiving S312A may correspond to S906 in FIG. 2.

In one or more example methods, monitoring S312 comprises interpreting S312B, such as reading, the paging indication based on the paging group identifier of the determined paging group. The wireless device may use the paging group identifier of its paging group to determine whether the paging DCI is intended for the wireless device, such as by determining whether the RMSI/TMSI of the wireless device is comprised in the DCI.

In one or more example methods, interpreting S312B the paging indication based on a paging group identifier comprises decoding S312BA the paging indication based on the paging group identifier. Decoding S312BA the paging indication may comprise unscrambling and/or unmasking the paging indication using the paging group identifier, such as the paging group identifier of the paging group that the wireless device belongs to.

In one or more example methods, the paging indication comprises one or more bits associated with the paging group. In one or more example methods, interpreting S312B the paging indication based on a paging group identifier comprises interpreting S312BB the paging indication based on the one or more bits associated with the paging group. The wireless device may only monitor succeeding PDSCH when the one or more bits in the DCI matches the paging group of the wireless device.

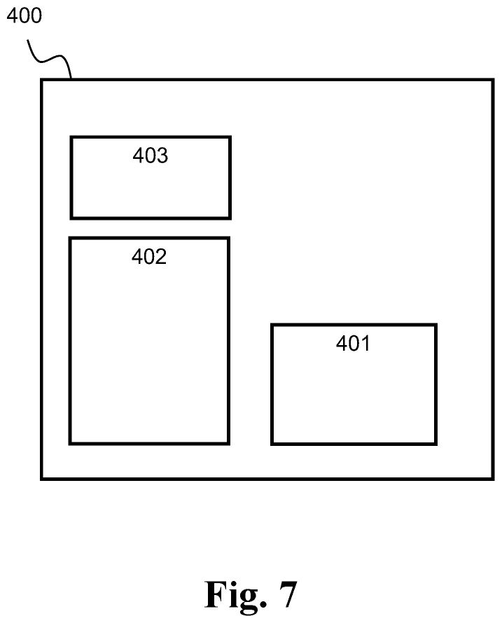

FIG. 7 shows a block diagram of an example RAN node 400 according to the disclosure. The RAN node 400 comprises circuitry, such as memory circuitry 401, processor circuitry 402, and an interface 403, configured to cause the RAN node 400 to perform any of the methods disclosed in FIG. 4. In other words, the RAN node 400 may be configured for paging one wireless device of one or more wireless devices monitoring paging in a cell controlled by the RAN node.

The RAN node 400 is configured to broadcast, for example via the interface 403, RAN signaling for use in determining a paging group by the wireless device.

The RAN node 400 is configured to receive, for example via the interface 403, from a core network, CN, node, a paging request to page the wireless device, wherein the paging request is indicative of assistance information for paging of the wireless device.

The RAN node 400 is configured to transmit, for example via the interface 403, a paging indication indicative of a paging group determined based on the paging request.

The interface 403 is configured for wired communication and/or for wireless communications via a wireless communication system, such as a 3GPP system, such as a 3GPP system supporting NR or LTE.

The processor circuitry 402 is optionally configured to perform any of the operations disclosed in FIG. 4 (such as any one or more of S102, S108, S108A, S108AA, S108AB, S108B, S109, S109A, S110). The operations of the RAN node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the RAN node 400 may be considered a method that the RAN node 400 is configured to carry out. Also, while the described functions and operations may be implemented in software, such functionality may as well be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 7). Memory circuitry 401 is considered a non-transitory computer readable medium.

Memory circuitry 401 may be configured to store information (such as assistance information, paging group information and/or paging request) in a part of the memory.

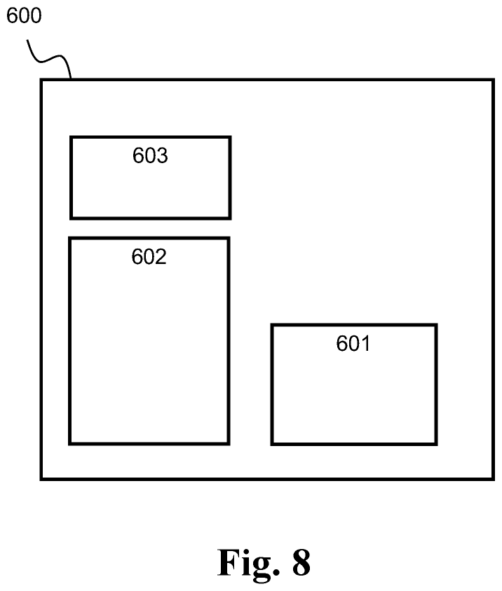

FIG. 8 shows a block diagram of an example core network node 600 according to the disclosure. The core network node 600 comprises circuitry, such as memory circuitry 601, processor circuitry 602, and an interface 603. The core network node 600 may be configured to perform any of the methods disclosed in FIG. 5. In other words, the core network node 600 may be configured for paging one wireless device of one or more wireless devices monitoring paging in a cell controlled by a Radio Access Network, RAN, node. The core network node 600 may for example be an MME or an AMF.

The core network node 600 is configured to communicate with the RAN node, such as the RAN node 400 disclosed herein, using the interface 603, such as an S1 or an NG interface.

The core network node 600 is optionally configured to transmit (such as via the interface 603), to the RAN node, control signaling assisting the RAN node in determining paging groups based on paging probability.

The core network node 600 is configured to transmit (such as via the interface 603), to the RAN node, a paging request to page the wireless device, wherein the paging request is indicative of assistance information for paging.

The core network node 600 is optionally configured to perform any of the operations disclosed in FIG. 5 (such as any one or more of S202, S204). The operations of the core network node 600 may be embodied in the form of executable logic routines (for example, lines of code, software programs, etc.) that are stored on a non-transitory computer readable medium (for example, memory circuitry 601) and are executed by processor circuitry 602).

Furthermore, the operations of the core network node 600 may be considered a method that the core network node 600 is configured to carry out. Also, while the described functions and operations may be implemented in software, such functionality may as well be carried out via dedicated hardware or firmware, or some combination of hardware, firmware and/or software.

Memory circuitry 601 may be one or more of a buffer, a flash memory, a hard drive, a removable media, a volatile memory, a non-volatile memory, a random access memory (RAM), or other suitable device. In a typical arrangement, memory circuitry 601 may include a non-volatile memory for long term data storage and a volatile memory that functions as system memory for processor circuitry 602. Memory circuitry 601 may exchange data with processor circuitry 602 over a data bus. Control lines and an address bus between memory circuitry 601 and processor circuitry 602 also may be present (not shown in FIG. 8). Memory circuitry 601 is considered a non-transitory computer readable medium.

Memory circuitry 601 may be configured to store information (such as assistance information, paging group information and/or paging request) in a part of the memory.

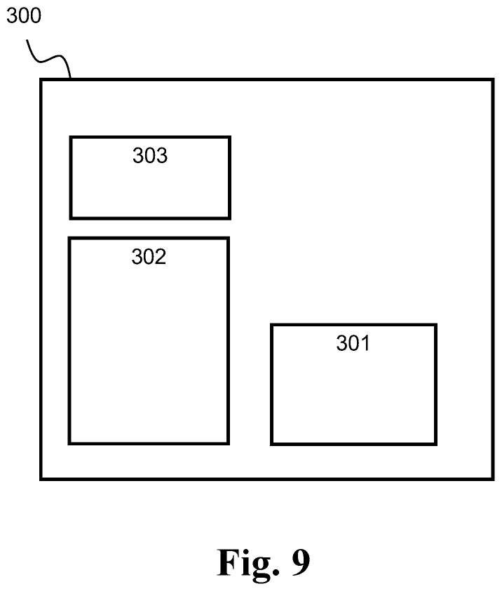

FIG. 9 shows a block diagram of an example wireless device 300 according to the disclosure. The wireless device 300 comprises circuitry, such as memory circuitry 301, processor circuitry 302, and a wireless interface 303. The wireless device 300 may be configured to perform any of the methods disclosed in FIG. 6. In other words, the wireless device 300 may be configured for handling paging of the wireless device, wherein the wireless device is monitoring paging in a cell controlled by a RAN node.

The wireless device 300 is configured to communicate with a network node, such as the RAN node 400 disclosed herein, using a wireless communication system.

The wireless device 300 is configured to receive, such as via the wireless interface 303, from the RAN node, RAN signaling enabling the wireless device to determine its paging group.

The wireless device 300 is configured to determine, such as via the processor circuitry 302, a paging group based on the RAN signaling.

The wireless device 300 is configured to monitor, such as via the wireless interface 303 and/or the processor circuitry 302, a paging occasion for a paging indication indicative of the determined paging group.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution —enhanced Machine Type Communication, LTE-M.

The wireless device 300 is optionally configured to perform any of the operations disclosed in FIG. 6 (such as any one or more of S302, S304, S312A, S312B, S312BA, S312BB). The operations of the wireless device 300 may be embodied in the form of executable logic routines (for example, lines of code, software programs, etc.) that are stored on a non-transitory computer readable medium (for example memory circuitry 301) and are executed by processor circuitry 302).

Furthermore, the operations of the wireless device 300 may be considered a method that the wireless device 300 is configured to carry out. Also, while the described functions and operations may be implemented in software, such functionality may as well be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 9). Memory circuitry 301 is considered a non-transitory computer readable medium.

Memory circuitry 301 may be configured to store information (such as wireless device information, assistance information) in a part of the memory.

Embodiments of methods and products (network node and wireless device) according to the disclosure are set out in the following items:
Item 1. A method, performed by a Radio Access Network, RAN, node, for paging one wireless device of one or more wireless devices monitoring paging in a cell controlled by the RAN node, the method comprising:
   broadcasting (S104) RAN signaling for use in determining a paging group by the wireless device;
   receiving (S106), from a core network, CN, node, a paging request to page the wireless device, wherein the paging request is indicative of assistance information for paging of the wireless device; and
   transmitting (S110), to the wireless device, a paging indication indicative of a paging group determined based on the paging request.
Item 2. The method according to Item 1, wherein the paging group is indicated by formatting (S108A) the paging indication based on the paging group of the wireless device.
Item 3. The method according to Item 2, wherein formatting (S108A) the paging indication comprises encoding (S108AA) the paging indication with a paging group identifier.
Item 4. The method according to Item 2, wherein formatting (S108A) the paging indication comprises providing (S108AB) a paging group identifier in the paging indication.
Item 5. The method according to Item 4, wherein the paging group identifier is indicated by one or more bits of the paging indication, wherein the one or more bits are associated with the paging group.
Item 6. The method according to any of Items 4-5, wherein the paging group identifier is indicated by a dedicated bit of the paging indication, wherein the dedicated bit is associated with the paging group.
Item 7. The method according to any of Items 4-6, wherein the paging group identifier is indicated by a combination of bits of the paging indication, wherein the combination of bits is associated with the paging group.
Item 8. The method according to any of Items 1-7, wherein the paging group is indicated by transmitting the paging indication using a paging resource assigned to at least one of the paging groups.
Item 9. The method according to any one of the previous Items, the method comprising receiving (S102), from the CN node, control signaling assisting the RAN node in determining paging groups based on paging probability and/or traffic characteristics.
Item 10. The method according to Item 9, wherein the control signaling comprises one or more of: a range of paging probabilities, a distribution of paging probabilities, paging probability thresholds associated with each paging group, traffic characteristics associated with each paging group and a paging group identifier for each paging group.
Item 11. The method according to any one of the previous Items, wherein the assistance information for paging comprises one or more of: a paging probability associated with the wireless device, and a traffic characteristic for the wireless device.
Item 12. The method according to any one of the previous Items, wherein the paging request comprises a request to page a plurality of wireless devices, wherein the assistance information for paging comprises paging probability or traffic characteristics of each of the plurality of wireless devices.
Item 13. The method according to any one of the previous Items, wherein the method comprises determining (S108) the paging indication indicative of the paging group based on the paging request and the control signaling.
Item 14. The method according to Item 13, wherein determining (S108) the paging indication comprises determining (S108B) a paging occasion based on an increased maximum number of paging occasions per paging frame.
Item 15. The method according to any one of the previous Items, the method comprises:
   scheduling (S109), based on the paging groups, a paging occasion for each paging group.
Item 16. The method according to Item 15, wherein scheduling (S109), based on the paging groups, the paging occasion for each paging group, comprises multiplexing (S109A) the paging occasions in time and/or in frequency.
Item 17. The method according to any one of the previous Items, wherein the RAN signaling enables the wireless device to determine a paging group based on a paging probability or traffic characteristics of the wireless device.
Item 18. A method, performed by a core network node, for paging one wireless device of one or more wireless devices monitoring paging in a cell controlled by a Radio Access Network, RAN, node, the method comprising:
   transmitting (S208), to the RAN node, a paging request to page the wireless device, wherein the paging request is indicative of assistance information for paging.
Item 19. The method according to Item 18, the method comprising transmitting (S206), to the RAN node, control signaling assisting the RAN node in determining paging groups based on paging probability, and
Item 20. The method according to Item 19, wherein the control signaling comprises one or more of: a range of paging probabilities associated with each paging group, paging probability thresholds associated with each paging group, traffic characteristics associated with each paging group and a paging group identifier for each paging group.
Item 21. The method according to any one of the Items 18-20, wherein the paging request comprises one or more of: a paging probability associated with the wireless device, and a traffic characteristic for the wireless device.
Item 22. The method according to any of the previous Items 18-21, wherein the paging request comprises a request to page a plurality of wireless devices, wherein the paging request is indicative of paging probability or traffic characteristics of each of the plurality of wireless devices.
Item 23. The method according to any one of the Items 18-22, wherein the method comprises receiving (S202), from the wireless device, wireless device information; and transmitting (S204), to the wireless device, assistance information.
Item 24. The method according to any one of the Items 18-23, wherein the assistance information for paging comprises one or more of a paging probability and traffic characteristics.
Item 25. A method, performed by a wireless device, for handling paging of the wireless device, wherein the wireless device is monitoring paging in a cell controlled by a Radio Access Network, RAN, node, the method comprising:
   receiving (S306), from the RAN node, RAN signaling enabling the wireless device to determine its paging group;
   determining (S308) a paging group based on the RAN signaling; and
   monitoring (S312), a paging occasion for a paging indication indicative of the determined paging group.
Item 26. The method according to Item 25, wherein the monitoring (S312) comprises interpreting (S312B) the paging indication based on a paging group identifier of the determined paging group.
Item 27. The method according to Item 26, wherein interpreting (S312B) the paging indication based on a paging group identifier comprises decoding (S312BA) the paging indication based on the paging group identifier.
Item 28. The method according to any one of the Items 26 to 27, wherein the paging indication comprises one or more bits associated with the paging group, and wherein interpreting (S312B) the paging indication based on a paging group identifier comprises interpreting (S312BB) the paging indication based on the one or more bits associated with the paging group.
Item 29. The method according to any one of the Items 25 to 28, the method comprising: receiving (S314), from the RAN node, the paging indication indicative of the paging group.
Item 30. The method according to any one of the Items 25 to 29, wherein the RAN signaling is indicative of a rule for interpreting the paging indication.
Item 31. The method according to any one of the Items 25 to 30, wherein the RAN signaling is indicative of resources in time and/or frequency for the paging occasion.
Item 32. The method according to any one of the Items 25 to 31, wherein the RAN signaling enables the wireless device to determine a paging group based on a paging probability or traffic characteristics of the wireless device.
Item 33. A Radio Access Network, RAN, node comprising circuitry, wherein the circuitry is configured to cause the RAN node to perform any of the methods according to any of Items 1-17.
Item 34. A core network node comprising circuitry, wherein the circuitry is configured to cause the core network node to perform any of the methods according to any of Items 18-24.
Item 35. A wireless device comprising circuitry, wherein the circuitry is configured to cause the wireless device to perform any of the methods according to any of Items 25-32.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-9 comprises some circuitries or operations which are illustrated with a solid line and some circuitries or operations which are illustrated with a dashed line. Circuitries or operations which are comprised in a solid line are circuitries or operations which are comprised in the broadest example embodiment. Circuitries or operations which are comprised in a dashed line are example embodiments which may be comprised in, or a part of, or are further circuitries or operations which may be taken in addition to circuitries or operations of the solid line example embodiments. It should be appreciated that these operations need not be performed in order presented.

Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the example embodiments may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

### APPENDIX

Below we give a detailed configuration and setting of PF, PO, and PDCCH monitoring occasions.

The PF and PO for paging are determined by the following formulae:
SFN for the PF is determined by:

(SFN+PF_offset)mod T=(T div N)*(UE_ID mod N)
Index (i_s), indicating the index of the PO is determined by:

i_s=floor(UE_ID/N)mod Ns

where
T: DRX cycle of the UE (T is determined by the shortest of the UE specific DRX value(s), if configured by RRC and/or upper layers, and a default DRX value broadcast in system information. In RRC_IDLE state, if UE specific DRX is not configured by upper layers, the default value is applied).
N: number of total PFs in T
Ns: number of POs fora PF
PF_offset: offset used for PF determination
UE_ID: 5G-S-TMSI mod 1024

If the UE has no 5G-S-TMSI, for instance when the UE has not yet registered onto the network, the UE shall use as default identity UE_ID=0 in the PF and i_s formulas above.

5G-S-TMSI is a 48 bit long bit string as defined in TS 23.501. 5G-S-TMSI shall in the formulae above be interpreted as a binary number where the left most bit represents the most significant bit.

The PDCCH monitoring occasions include configuration to also support multi-beam operation. The PDCCH monitoring occasions for paging are determined according to pagingSearchSpace as specified in TS 38.213 and firstPDCCH-MonitoringOccasionOfPO and nrofPDCCH-MonitoringOccasionPerSSB-InPO if configured as specified in TS 38.331.

When SearchSpaceId=0 is configured for pagingSearchSpace, the PDCCH monitoring occasions for paging are same as for RMSI as defined in clause 13 in TS 38.213.

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.
NOTE 1: A PO associated with a PF may start in the PF or after the PF.
NOTE 2: The PDCCH monitoring occasions for a PO can span multiple radio frames. When SearchSpaceId other than 0 is configured for paging-SearchSpace the PDCCH monitoring occasions for a PO can span multiple periods of the paging search space.

In the formula given above, parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset as defined in TS 38.331 and in a Table below. The parameter first-PDCCH-MonitoringOccasionOfPO is signalled in SIB1 for paging in initial DL BWP. For paging in a DL BWP other than the initial DL BWP, the parameter first-PDCCH-MonitoringOccasionOfPO is signaled in the corresponding BWP configuration.

### DownlinkConfigCommonSIB Information Element (from TS 38.331)

-- ASN1START
-- TAG-DOWNLINKCONFIGCOMMONSIB-START

| | |
|---|---|
| DownlinkConfigCommonSIB ::= | SEQUENCE { |
| frequencyInfoDL | FrequencyInfoDL-SIB, |
| initialDownlinkBWP | BWP-DownlinkCommon, |
| bcch-Config | BCCH-Config, |
| pcch-Config | PCCH-Config, |

...
}

| | |
|---|---|
| BCCH-Config ::= | SEQUENCE { |
| modificationPeriodCoeff | ENUMERATED {n2, n4, n8, n16}, |

...
}

| PCCH-Config ::= | | SEQUENCE { |
|---|---|---|
| defaultPagingCycle | | PagingCycle, |
| nAndPagingFrameOffset | | CHOICE { |
| | oneT | NULL, |
| | halfT | INTEGER (0..1), |
| | quarterT | INTEGER (0..3), |
| | oneEighthT | INTEGER (0..7), |
| | oneSixteenthT | INTEGER (0..15) |

},

| ns | | ENUMERATED {four, two, one}, |
|---|---|---|
| firstPDCCH-MonitoringOccasionOfPO | | CHOICE { |
| | sCS15KHZoneT | SEQUENCE |

(SIZE (1..maxPO-perPF)) OF INTEGER (0..139),

| | |
|---|---|
| sCS30KHZoneT-SCS15KHZhalfT | SEQUENCE |

(SIZE (1..maxPO-perPF)) OF INTEGER (0..279),

| | |
|---|---|
| sCS60KHZoneT-SCS30KHZhalfT-SCS15KHZquarterT | SEQUENCE |

(SIZE (1..maxPO-perPF)) OF INTEGER (0..559),

| | |
|---|---|
| sCS120KHZoneT-SCS60KHZhalfT-SCS30KHZquarterT-SCS15KHZoneEighthT | SEQUENCE |

(SIZE (1..maxPO-perPF)) OF INTEGER (0..1119),

sCS120KHZhalfT-SCS60KHZquarterT-SCS30KHZoneEighthT-SCS15KHZoneSixteenthT

SEQUENCE

(SIZE (1..maxPO-perPF)) OF INTEGER (0..2239),

| | |
|---|---|
| sCS120KHZquarterT-SCS60KHZoneEighthT-SCS30KHZoneSixteenthT | SEQUENCE |

(SIZE (1..maxPO-perPF)) OF INTEGER (0..4479),

| | |
|---|---|
| sCS120KHZoneEighthT-SCS60KHZoneSixteenthT | SEQUENCE |

(SIZE (1..maxPO-perPF)) OF INTEGER (0..8959),

| | |
|---|---|
| sCS120KHZoneSixteenthT | SEQUENCE |

(SIZE (1..maxPO-perPF)) OF INTEGER (0..17919)

| | | |
|---|---|---|
| } | OPTIONAL, | -- Need R |

...
}
-- TAG-DOWNLINKCONFIGCOMMONSIB-STOP
-- ASN1STOP

PCCH-Config field descriptions

defaultPagingCycle
Default paging cycle, used to derive ‘T’ in TS 38.304 [20]. Value rf32 corresponds to 32 radio
frames, value rf64 corresponds to 64 radio frames and so on.
firstPDCCH-MonitoringOccasionOfPO
Points out the first PDCCH monitoring occasion for paging of each PO of the PF, see TS 38.304
[20].
nAndPagingFrameOffset
Used to derive the number of total paging frames in T (corresponding to parameter N in TS 38.304
[20]) and paging frame offset (corresponding to parameter PF_offset in TS 38.304 [20]). A value of
oneSixteenthT corresponds to T/16, a value of oneEighthT corresponds to T/8, and so on.
If pagingSearchSpace is set to zero and if SS/PBCH block and CORESET multiplexing pattern is 2
or 3 (as specified in TS 38.213 [13]):
for ssb-periodicityServingCell of 5 or 10 ms, N can be set to one of {oneT, halfT,
quarterT, oneEighthT, oneSixteenthT}
for ssb-periodicityServingCell of 20 ms, N can be set to one of {halfT, quarterT,
oneEighthT, oneSixteenthT}
for ssb-periodicityServingCell of 40 ms, N can be set to one of {quarterT,
oneEighthT, oneSixteenthT}
for ssb-periodicityServingCell of 80 ms, N can be set to one of {oneEighthT,
oneSixteenthT}
for ssb-periodicityServingCell of 160 ms, N can be set to oneSixteenthT
If pagingSearchSpace is set to zero and if SS/PBCH block and CORESET multiplexing pattern is 1
(as specified in TS 38.213 [13]), N can be set to one of {halfT, quarterT, oneEighthT, oneSixteenthT}
If pagingSearchSpace is not set to zero, N can be configured to one of {oneT, halfT, quarterT,
oneEighthT, oneSixteenthT}
ns
Number of paging occasions per paging frame.

1. A method, performed by a Radio Access Network (RAN) node, for paging one wireless device of one or more wireless devices monitoring paging in a cell controlled by the RAN node, the method comprising:
broadcasting RAN signaling for use in determining a paging group by the wireless device;
receiving, from a core network (CN) node, a paging request to page the wireless device, wherein the paging request is indicative of assistance information for paging of the wireless device; and
transmitting, to the wireless device, a paging indication indicative of a paging group determined based on the paging request.

2. The method according to claim 1, wherein the paging group is indicated by formatting the paging indication based on the paging group of the wireless device.

3. The method according to claim 2, wherein formatting the paging indication comprises encoding the paging indication with a paging group identifier.

4. The method according to claim 2, wherein formatting the paging indication comprises providing a paging group identifier in the paging indication.

5. The method according to claim 4, wherein the paging group identifier is indicated by one or more bits of the paging indication, wherein the one or more bits are associated with the paging group.

6. The method according to claim 4, wherein the paging group identifier is indicated by a dedicated bit of the paging indication, wherein the dedicated bit is associated with the paging group.

7. The method according to claim 4, wherein the paging group identifier is indicated by a combination of bits of the paging indication, wherein the combination of bits is associated with the paging group.

8. The method according to claim 1, wherein the paging group is indicated by transmitting the paging indication using a paging resource assigned to at least one of the paging group.

9. The method according to claim 1, the method comprising receiving, from the CN node, control signaling assisting the RAN node in determining paging groups based on paging probability and/or traffic characteristics.

10. The method according to claim 9, wherein the control signaling comprises one or more of: a range of paging probabilities, a distribution of paging probabilities, paging probability thresholds associated with each paging group, traffic characteristics associated with each paging group and a paging group identifier for each paging group.

11. The method according to claim 1, wherein the assistance information for paging comprises one or more of: a paging probability associated with the wireless device, and a traffic characteristic for the wireless device.

12. The method according to claim 1, wherein the paging request comprises a request to page a plurality of wireless devices, wherein the assistance information for paging comprises paging probability or traffic characteristics of each of the plurality of wireless devices.

13. The method according claim 1, wherein the method comprises determining the paging indication indicative of the paging group based on the paging request and the control signaling.

14. The method according to claim 13, wherein determining the paging indication comprises determining a paging occasion based on an increased maximum number of paging occasions per paging frame.

15. The method according to claim 1, the method comprises:
scheduling, based on the paging groups, a paging occasion for each paging group.

16. The method according to claim 15, wherein scheduling, based on the paging groups, the paging occasion for each paging group, comprises multiplexing the paging occasions in time and/or in frequency.

17. The method according to claim 1, wherein the RAN signaling enables the wireless device to determine a paging group based on a paging probability or traffic characteristics of the wireless device.

18. A method, performed by a core network node, for paging one wireless device of one or more wireless devices monitoring paging in a cell controlled by a Radio Access Network (RAN) node, the method comprising:
transmitting, to the RAN node, a paging request to page the wireless device, wherein the paging request is indicative of assistance information for paging.

19. The method according to claim 18, the method comprising transmitting, to the RAN node, control signaling assisting the RAN node in determining paging groups based on paging probability.

20. The method according to claim 19, wherein the control signaling comprises one or more of: a range of paging probabilities associated with each paging group, paging probability thresholds associated with each paging group, traffic characteristics associated with each paging group and a paging group identifier for each paging group.

21-35. (canceled)
